(19) United States
(12) Patent Application Publication
(10) Pub. No.: US 2026/0138469 A1
(43) Pub. Date: May 21, 2026

(54) Fuel-Cell Assembly for a Motor Vehicle, Drive Device, and Motor Vehicle

(71) Applicant: Bayerische Motoren Werke Aktiengesellschaft, Muenchen (DE)

(72) Inventors: Patrik LOFERER, Oberschleissheim (DE); Christoph Toni WILHELM, Muenchen (DE)

(21) Appl. No.: 19/114,829

(22) PCT Filed: Oct. 17, 2023
(86) PCT No.: PCT/EP2023/078787

§ 371 Date: Mar. 25, 2025

(30) Foreign Application Priority Data
Oct. 17, 2022 (DE) 10 2022 127 048.3

(51) Int. Cl. B60L 50/72; H01M 8/02; H01M 8/0662; H01M 8/2475

(52) U.S. Cl. CPC B60L 50/72; H01M 8/02; H01M 8/0687; H01M 8/2475; H01M 2250/20

(57) ABSTRACT

A fuel-cell assembly for a motor vehicle includes a plurality of electrode plates which together form a fuel-cell stack, one or more bus bars which, when installed, are arranged below the fuel-cell stack, and an intake noise absorber. The intake noise absorber is arranged above the fuel-cell stack.

### BACKGROUND AND SUMMARY

The technology disclosed herein relates to a fuel-cell assembly for a motor vehicle, to a drive device for a motor vehicle, and to a motor vehicle.

Fuel cells are used to convert gaseous or liquid energy sources, for example hydrogen, into electric current and can therefore be used to supply a motor vehicle with energy. The installation of a fuel cell in a motor vehicle typically requires taking into consideration defined installation spaces and optimizing the space requirement.

A preferred object of the technology disclosed herein is to reduce or eliminate at least one drawback of a previously known solution or to propose an alternative solution. In particular, a preferred object of the technology disclosed herein is to optimize and/or reduce a space requirement of fuel cells. Further preferred objects can be gathered from the advantageous effects of the technology disclosed herein. The objects are achieved by the subject matter of the independent claims. The dependent claims present preferred refinements.

The technology disclosed herein relates to a fuel-cell assembly for a motor vehicle, comprising (i) a plurality of electrode plates which together form a fuel-cell stack, and (ii) one or more busbars which electrically connect the electrode plates, wherein, in an installed state, the busbars are arranged beneath the fuel-cell stack. It has been found that, as a result of such a configuration, the space requirement of a fuel-cell assembly can be optimized, in particular since other components, for example an electric drive machine, can engage between the busbars from below. In addition, as a result of the busbars being arranged on the underside, an intake noise absorber, which is typically arranged above the fuel-cell assembly, is not additionally raised.

The electrode plates are in particular plates at which electrochemical processes for converting fuel into electrical energy take place. Typically, a fuel-cell stack has a plurality of electrode plates, which are oriented parallel to one another. They are connected electrically together in a suitable manner. The busbars serve typically to electrically connect the electrode plates and to establish electrical connections and to connect the fuel-cell stack such that the latter can output electrical energy to other components of a motor vehicle. An installed state is typically understood to be that particular state which the fuel-cell stack or the fuel-cell assembly takes up in a motor vehicle in the normal position of the motor vehicle on the road. Such an installed state is typically discernible in a fuel-cell stack, even when the latter has not yet been installed in a motor vehicle. In particular, media lines and/or connections to other components can be used for this purpose.

In particular, it may be provided that, in the installed state, the busbars are arranged only beneath the fuel-cell stack. This may mean in particular that no busbars are arranged above the fuel-cell stack or next to the fuel-cell stack. This may in particular allow a simplified power supply and also save space.

Preferably, the fuel-cell assembly has a housing that encloses the fuel-cell stack and/or the busbars. Such a housing may serve, for example, to protect the fuel-cell stack and to delimit it with respect to other components. However, it may also be formed integrally with other components. Typically, various feed-throughs for media connections and/or electrical connections pass through the housing.

One or more ribs may be formed in particular above the fuel-cell stack in the housing. Such ribs may, for example, realize a cooling function and/or may allow an advantageous connection to other components, for example an intake noise absorber. In particular, another component, for example parts of an intake noise absorber, may be accommodated between the ribs. This allows a particularly space-saving configuration.

According to an advantageous configuration, the fuel-cell assembly also has an intake noise absorber which, in the installed state, is arranged in particular above the fuel-cell stack. In particular, the intake noise absorber may, in the installed state, be arranged only above the fuel-cell stack. Such an intake noise absorber is typically designed to suitably guide drawn-in air and to provide it for use within a fuel cell, for example by filtering. To this end, the intake noise absorber may have, for example, an air filter. The intake noise absorber may also have various channels or other air-guiding components, in order to ensure suitable and low-noise air guidance. The arrangement above the fuel-cell stack allows an advantageous supply of the fuel cell and a space-saving arrangement. In particular, the intake noise absorber is an element which acts specifically in the drawn-in air. Thus, noise that is generated by such drawn-in air is reduced. The intake noise absorber is thus different than noise insulating components, which encase, for example, the fuel-cell stack, the housing or at least part thereof and which may be formed, for example, from noise insulating components.

The intake noise absorber may engage, in particular, in one or more spaces between the ribs. This allows a particular space-saving configuration, since parts can be arranged between the ribs which would otherwise have to be arranged above the ribs.

An underside of the intake noise absorber may in particular be formed in a complementary manner to a top side of the housing. This allows a particularly space-saving configuration. A complementary configuration should be understood in particular as meaning that as small a distance as possible is formed between the intake noise absorber and the housing at all or at least some points, wherein the underside of the intake noise absorber may, in particular, also bear directly on the top side of the housing. As a result, a particularly space-saving configuration is achieved.

In particular, above the fuel-cell stack, the housing may be formed entirely or partially integrally with the intake noise absorber. This allows a dual use of the housing, specifically as a housing for the fuel-cell stack and for the intake noise absorber. As a result, it is possible to dispense with duplicated components. This makes it possible to save installation space and weight. An integral configuration may be understood in particular as meaning that the housing simultaneously forms a constituent part of the intake noise absorber.

Preferably, the intake noise absorber is arranged above the housing. The housing thus in particular does not enclose the intake noise absorber. In particular, provision may be made for the housing to enclose, of the components mentioned herein, only or at least substantially only the fuel-cell stack and the busbars.

In particular, the electrode plates may be oriented parallel to one another. This allows advantageous electrical connection and a space-saving arrangement. The electrode plates may, in particular, be oriented vertically in the installed state. As a result, they may be electrically connected advantageously from one side, for example the underside. The busbars arranged there may be used for such connection.

The intake noise absorber may in particular have an air filter. This makes it possible to filter air, such that the penetration of dirt or moisture is prevented.

The technology disclosed herein also relates to a drive device for a motor vehicle, comprising (i) a fuel-cell assembly as described herein, and (ii) an electric motor. With regard to the fuel-cell assembly, reference may be made to all of the configurations described herein. The electric motor may in particular be supplied with current from the fuel-cell assembly and may provide propulsion for a motor vehicle.

The electric motor may in particular be arranged beneath the fuel-cell stack. This allows a space-saving arrangement. In particular, the electric motor may have a motor housing which engages in a space between at least two busbars. This allows a particularly space-saving arrangement since the space between the two busbars is otherwise typically not used for anything else and thus a particularly close arrangement of the fuel-cell assembly above the electric motor is possible.

The technology disclosed herein also relates to a motor vehicle comprising a fuel-cell assembly as described herein or a drive device as described herein. With regard to the fuel-cell assembly or the drive device, reference may be made to all of the configurations described herein.

In other words, it is in particular appropriate, in the case of fuel-cell electric drives in vehicles, to optimize the overall system in all spatial directions. On account of their high efficiency and low emissions, fuel cells, in addition to rechargeable batteries, are among the most important power sources which are being development for future mobility. For example, a fuel-cell stack having a plurality of fuel cells arranged in series can be used. Each of these fuel cells typically has an anode and a cathode which are separated from one another by an electrolyte and a special membrane. For example, hydrogen is fed to an anode and oxygen is fed to the cathode. As a result of an electrochemical reaction, electrical energy is thus produced. The electrical energy can be used in particular to operate at least one electric machine installed in the vehicle. The oxygen for the cathode can be guided in particular via an intake noise absorber into a cathode subsystem responsible for an optimal air supply. The intake noise absorber may be arranged for example on a top side and/or an underside in a fuel-cell electric assembly above the fuel-cell stack.

The configuration described herein relates, inter alia, to an improved arrangement above the fuel-cell stack in order to optimize the spatial extension of the fuel-cell electric drive in the z direction. In order to allow such optimization, any busbars are removed from the top side of the fuel-cell stack and located on the underside of the fuel-cell stack. The shape of the underside of the intake noise absorber may be matched to the shape of the top side of the fuel-cell stack such that the two components are inserted optimally into one another and/or the underside of the intake noise absorber can be fastened to the top side of the fuel-cell stack. Alternatively, it is possible, for example, for the underside of the intake noise absorber to be integrated with the top side of the fuel-cell stack to form a common component.

As a result of the matching of the shape of the underside of the intake noise absorber or as a result of the integration of the component with the top side of the fuel-cell stack, the spatial extension of the fuel-cell electric drive in the z direction is reduced. Thus, there is sufficient pedestrian protection even when the hood has a low height, and so the fuel-cell electric drive is suitable for use even in smaller vehicle types. Furthermore, the electric machine is able to be placed on the front axle as a result of any busbars being located on the underside of the fuel-cell stack and/or beneath the fuel-cell stack.

A fuel cell is intended for example for mobile applications such as motor vehicle (for example passenger cars, motorcycles, commercial vehicles), in particular for the provision of the energy for at least one drive machine for the locomotion of the motor vehicle. In its simplest form, a fuel cell is an electrochemical energy converter which converts fuel (for example hydrogen) and oxidizers (for example air, oxygen and peroxides) into reaction products and in the process produces electricity and heat.

The technology disclosed herein will now be described with reference to the figures.

### BRIEF DESCRIPTION OF THE DRAWINGS

FIG. 1 shows a drive device according to a first exemplary embodiment; and

FIG. 2 shows a drive device according to a second exemplary embodiment.

### DETAILED DESCRIPTION OF THE DRAWINGS

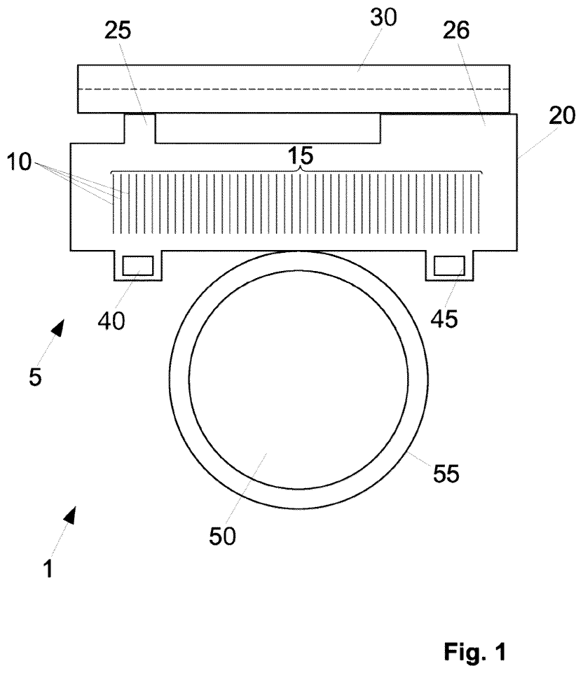

FIG. 1 shows, purely schematically, a drive device 1 according to a first exemplary embodiment. The drive device 1 has a fuel-cell assembly 5. The fuel-cell assembly 5 has a plurality of electrode plates 10 which together form a fuel-cell stack 15. The electrode plates 10 extend parallel to one another in a respective plane transversely to the paper plane of FIG. 1. The electrode plates 10 are arranged in a housing 20 which encloses the fuel-cell stack 15.

Formed on the top side of the housing 20 are two ribs 25, 26 which protrude upwardly and in particular stiffen the housing 20. Formed above the housing 20 is an intake noise absorber 30 which bears on the ribs 25, 26.

Arranged beneath the fuel-cell stack 15 are a first busbar 40 and a second busbar 45. These extend transversely to the paper plane of FIG. 1. Since FIG. 1 shows an installed state, the fuel-cell stack 15 is located above these busbars 40, 45 in an installed state, wherein the electrode plates 10 are electrically connected by the busbars 40, 45 in a manner not illustrated in more detail. The housing 20 also encloses the busbars 40, 45.

The drive device 1 also has an electric motor 50 having a motor housing 55. The motor housing 55 engages, as shown, in a space between the two busbars 40, 45, wherein a particularly space-saving configuration is achieved. Put another way, the space between the busbars 40, 45 can be used to reduce the overall height of the assembly made up of the electric motor 50 and fuel-cell assembly 5.

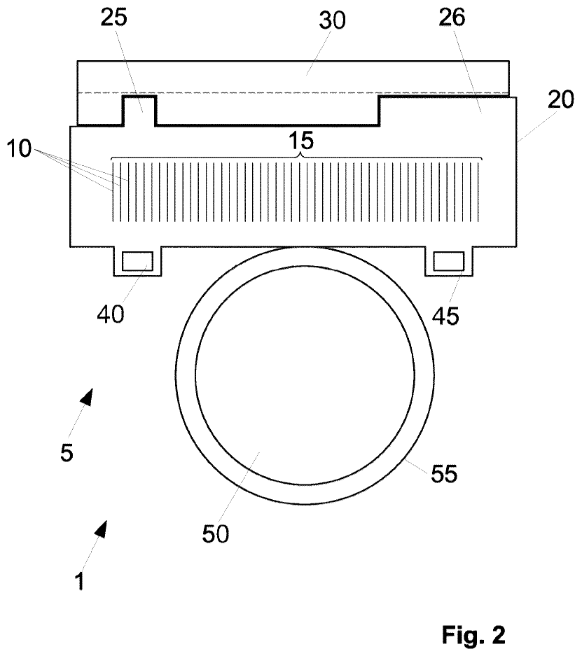

FIG. 2 shows a drive device 1 according to a second exemplary embodiment. For the most part, reference is made to the description of the first exemplary embodiment. In contrast to the first exemplary embodiment, however, the intake noise absorber 30 engages partially in a space between the two ribs 25, 26, with the result that an even greater reduction in the overall height is achieved. Thus, mutual engagement of components can be realized at the top side in a similar way to at the underside, resulting in particularly efficient use of the available installation space in particular in the z direction.

For reasons of legibility, the expression “at least one” has in some cases been omitted for simplification purposes. If a feature of the technology disclosed herein is described in the singular or in an indefinite manner (for example the/a fuel-cell stack, the/an electric motor, etc.), the plural thereof is also intended to be disclosed at the same time (for example the at least one fuel-cell stack, the at least one electric motor, etc.).

The above description of the present invention serves only for illustrative purposes and not to limit the invention. In the context of the invention, various amendments and modifications are possible without departing from the scope of the invention and its equivalents.

### LIST OF REFERENCE SIGNS

1 Drive device
5 Fuel-cell assembly
10 Electrode plates
15 Fuel-cell stack
20 Housing
25 Rib
26 Rib
30 Intake noise absorber
40 First busbar
45 Second busbar
50 Electric motor
55 Motor housing

1.-15. (canceled)

16. A fuel-cell assembly for a motor vehicle, comprising:
a plurality of electrode plates which together form a fuel-cell stack;
one or more busbars which electrically connect the electrode plates; and
an intake noise absorber,
wherein, in an installed state, the one or more busbars are arranged beneath the fuel-cell stack, and
wherein the intake noise absorber is arranged above the fuel-cell stack.

17. The fuel-cell assembly according to claim 16, further comprising:
a housing that encloses the fuel-cell stack and the one or more busbars.

18. The fuel-cell assembly according to claim 17, wherein
one or more ribs are formed above the fuel-cell stack in the housing.

19. The fuel-cell assembly according to claim 18, wherein
the intake noise absorber engages in space between two ribs.

20. The fuel-cell assembly according to claim 18, wherein
an underside of the intake noise absorber is formed in a complementary manner to a top side of the housing.

21. The fuel-cell assembly according to claim 17, wherein
an underside of the intake noise absorber is formed in a complementary manner to a top side of the housing.

22. The fuel-cell assembly according to claim 17, wherein
above the fuel-cell stack, the housing is formed entirely or partially integrally with the intake noise absorber.

23. The fuel-cell assembly according to claim 17, wherein
the intake noise absorber is arranged above the housing.

24. The fuel-cell assembly according to claim 16, wherein
in the installed state, the one or more busbars are arranged only beneath the fuel-cell stack, and/or,
in the installed state, the intake noise absorber is arranged only above the fuel-cell stack.

25. The fuel-cell assembly according to claim 16, wherein
the plurality of electrode plates are oriented parallel to one another.

26. The fuel-cell assembly according to claim 16, wherein the plurality of electrode plates are oriented vertically in the installed state.

27. The fuel-cell assembly according to claim 16, wherein the intake noise absorber has an air filter.

28. A drive device for a motor vehicle, comprising:
a fuel-cell assembly comprising:
a plurality of electrode plates which together form a fuel-cell stack;
one or more busbars which electrically connect the electrode plates; and
an intake noise absorber,
wherein, in an installed state, the one or more busbars are arranged beneath the fuel-cell stack, and
wherein the intake noise absorber is arranged above the fuel-cell stack; and
an electric motor, the electric motor being powered by the fuel-cell assemby.

29. The drive device according to claim 28, wherein
the electric motor is arranged beneath the fuel-cell stack.

30. The drive device according to claim 29, wherein
the electric motor has a motor housing which engages in a space between at least two busbars.

31. A motor vehicle comprising a fuel-cell assembly according to claim 16.
